(19) United States
(12) Patent Application Publication
(10) Pub. No.: US 2010/0205256 A1
(43) Pub. Date: Aug. 12, 2010

(54) ASSET STATE CHANGE EVENT PROCESSING

(76) Inventors: Kiet Q. Nguyen, Cary, NC (US); Annapureddy S. Reddy, Cary, NC (US); Shubha S. Tangirala, Raleigh, NC (US)

Correspondence Address: IBM CORPORATION, 3039 CORNWALLIS RD., DEPT. T81 / B503, PO BOX 12195, RESEARCH TRIANGLE PARK, NC, 27709, US

(21) Appl. No.: 12/367,797

(22) Filed: Feb. 9, 2009

(51) Int. Cl. G06F 15/16

(52) U.S. Cl. 709/206

(57) ABSTRACT

Asset state change events are processed using an asset-state identifier corresponding to a combination of the current state for the asset and the asset. The asset-state identifier uniquely identifies the combination from all other possible combinations of assets and states being monitored. When a new asset is identified, the asset-state identifiers can be generated and stored for subsequent use in updating the current state of the asset. In an embodiment, an event source in a business activity monitoring (BAM) system can send an update message that includes one or more asset-state identifiers for processing by a messaging system. Multiple asset-state identifiers can be processed by the messaging system and/or a monitoring system within a single transaction.

### TECHNICAL FIELD

The disclosure relates generally to event processing, and more particularly, to processing business activity monitoring (BAM) events.

### BACKGROUND ART

In general, business activity monitoring (BAM) provides information on various mission-critical activities occurring within a business in real time. To this extent, a BAM system attempts to provide a set of user interfaces that enable a user (e.g., a high-level manager) to view the current status of the business in real time. In a typical BAM system, for each significant event, such as the creation of a new monitored entity or a state change for a monitored entity, an event source transmits at least one message regarding the event to a messaging layer for processing. The message(s) typically include few details regarding the event/monitored entity, the full details of which can be accessed, when required, from an application database.

In processing a message for an event, the event source typically performs at least one transaction to generate and transmit the message to the messaging layer. Additionally, the messaging layer typically performs at least one transaction to filter and route the incoming messages to an appropriate monitor model queue, e.g., based on x-path filters, for further processing. Finally, the monitor model specific application processes the message and performs at least one database transaction for the event. Some BAM systems enable the use of batch update messages, which include information on multiple events in a single message. However, the messaging layer and monitor model specific application still need to process each event, typically within a separate transaction for each event.

Often, a BAM system monitors events for an asset having a very long or near perpetual lifecycle. For example, such systems include an airline tracking system that tracks aircraft status, a train tracking system, automobile fleet monitoring system, and/or the like. In these systems, the assets have a known group of states and a state for each asset may change numerous times over the lifecycle of the asset.

### SUMMARY OF THE INVENTION

Aspects of the invention provide a solution in which asset state change events are processed using an asset-state identifier corresponding to a combination of the current state for the asset and the asset. The asset-state identifier uniquely identifies the combination from all other possible combinations of assets and states being monitored. When a new asset is identified, the asset-state identifiers can be generated and stored for subsequent use in updating the current state of the asset. In an embodiment, an event source in a business activity monitoring (BAM) system can send an update message that includes one or more asset-state identifiers for processing by a messaging system. Multiple asset-state identifiers can be processed by the messaging system and/or a monitoring system within a single transaction.

A first aspect of the invention provides a computer-implemented method of monitoring assets, the method comprising: receiving asset state change data for an asset at a first computer system, wherein the asset is a physical object utilized by an enterprise and wherein the asset change data includes a current state of the asset; generating an update message based on the asset state change data with the first computer system, wherein the generating includes: obtaining an asset-state identifier corresponding to a combination of the current state for the asset and the asset, wherein the asset-state identifier uniquely identifies the combination from all other possible combinations of assets and states being monitored; and adding the unique identifier to the update message; and transmitting the update message for processing by a second computer system.

A second aspect of the invention provides a computer system for monitoring assets, the computer system comprising: an event source including: a component configured to receive asset state change data for an asset, wherein the asset change data includes a current state of the asset; a component configured to generate an update message based on the asset state change data by obtaining an asset-state identifier corresponding to a combination of the current state for the asset and the asset, wherein the asset-state identifier uniquely identifies the combination from all other possible combinations of assets and states being monitored, and adding the unique identifier to the update message; and a component configured to transmit the update message for processing by a messaging system.

A third aspect of the invention provides a computer program comprising program code embodied in at least one computer-readable medium, which when executed, enables a computer system to implement a method of monitoring assets, the method comprising: receiving asset state change data for an asset, wherein the asset is a physical object utilized by an enterprise and wherein the asset change data includes a current state of the asset; generating an update message based on the asset state change data, wherein the generating includes: obtaining an asset-state identifier corresponding to a combination of the current state for the asset and the asset, wherein the asset-state identifier uniquely identifies the combination from all other possible combinations of assets and states being monitored; and adding the unique identifier to the update message; and transmitting the update message for processing by a second computer system.

A fourth aspect of the invention provides a method of generating a computer system for monitoring assets, the method comprising: providing a computer system operable to: receive asset state change data for an asset at a first computing device, wherein the asset is a physical object utilized by an enterprise and wherein the asset change data includes a current state of the asset; generate an update message based on the asset state change data with the first computing device, wherein the generating includes: obtaining an asset-state identifier corresponding to a combination of the current state for the asset and the asset, wherein the asset-state identifier uniquely identifies the combination from all other possible combinations of assets and states being monitored; and adding the unique identifier to the update message; and transmit the update message for processing by a second computing device.

A fifth aspect of the invention provides a method comprising: at least one of providing or receiving a copy of a computer program that is encoded in a set of data signals, wherein the computer program enables a computer system to implement a method of monitoring assets, the method comprising: receiving asset state change data for an asset at a first computer system, wherein the asset is a physical object utilized by an enterprise and wherein the asset change data includes a current state of the asset; generating an update message based on the asset state change data with the first computer system, wherein the generating includes: obtaining an asset-state identifier corresponding to a combination of the current state for the asset and the asset, wherein the asset-state identifier uniquely identifies the combination from all other possible combinations of assets and states being monitored; and adding the unique identifier to the update message; and transmitting the update message for processing by a second computer system.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows an illustrative computing environment for an organization according to an embodiment.

FIG. 2 shows an illustrative implementation of an event source according to an embodiment.

FIGS. 3A-3B show illustrative processes performed in response to a new asset event according to an embodiment.

FIGS. 4A-4B show illustrative processes performed in response to a set of asset state change events according to an embodiment.

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the invention provide a solution in which asset state change events are processed using an asset-state identifier corresponding to a combination of the current state for the asset and the asset. The asset-state identifier uniquely identifies the combination from all other possible combinations of assets and states being monitored. When a new asset is identified, the asset-state identifiers can be generated and stored for subsequent use in updating the current state of the asset. In an embodiment, an event source in a business activity monitoring (BAM) system can send an update message that includes one or more asset-state identifiers for processing by a messaging system. Multiple asset-state identifiers can be processed by the messaging system and/or a monitoring system within a single transaction. As used herein, unless otherwise noted, the term “set” means one or more (i.e., at least one) and the phrase “any solution” means any now known or later developed solution.

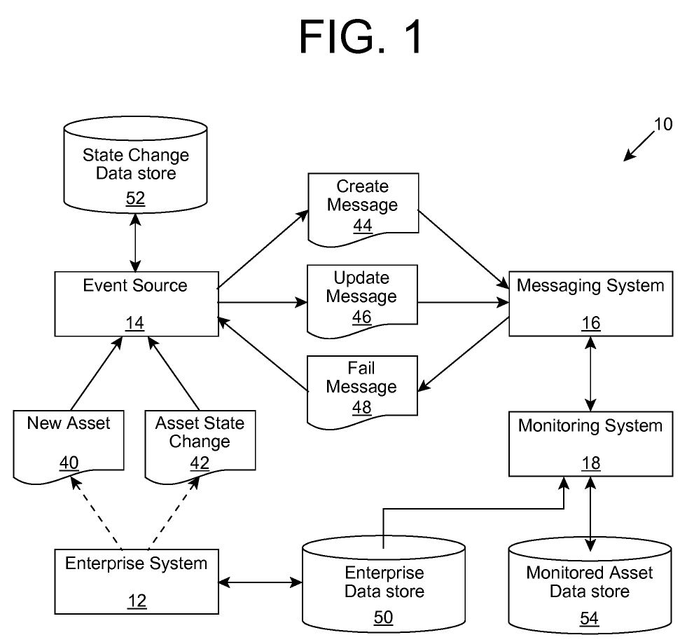

Turning to the drawings, FIG. 1 shows an illustrative computing environment 10 for an organization according to an embodiment. Computing environment 10 includes an enterprise system 12, which manages the operations and various assets of an organization (e.g., a business, a government entity, etc.). To this extent, enterprise system 12 includes a set of mission critical information technology components, which enable enterprise system 12 to manage (e.g., create, modify, store, delete, display, etc.) data that is used by the organization to perform day-to-day activities and/or monitor the day-to-day activities and the corresponding assets of the organization. As part of performing these actions, enterprise system 12 can read and write the data to an enterprise data store 50, which can comprise any type of storage hierarchy and which can store and manipulate the data using any combination of one or more data structures. As used herein, it is understood that an asset of an organization includes any type of physical object, including an individual performing activities on behalf of the organization, that is under the control of the organization. Further, a physical object can comprise a copy of a software product or a module thereof, which is available for use by the organization, e.g., stored on a set of storage devices, installed and configured on enterprise system 12, and/or the like.

Further, computing environment 10 includes a set of event sources 14. Each event source 14 comprises a computing component configured to monitor the operation of one or more components of enterprise system 12 for significant events corresponding to a monitored class of assets. The significant events can comprise any type of events, such as the addition of a new asset, removal of an asset, change of state of an asset, and/or the like. In an embodiment, an event source 14 can comprise software, such as an agent, which is configured to monitor enterprise system 12 for one or more significant events with respect to asset(s) of a particular type using any solution. For example, an event source 14 can monitor communications between two or more applications executing in enterprise system 12, monitor data being read from/written to enterprise data store 50, monitor data being communicated to enterprise system 12 from one or more other systems and/or user devices, and/or the like.

Regardless, when event source 14 detects a significant event for a monitored asset type, event source 14 can obtain data on the event and asset instance using any solution. For example, event source 14 can extract the data from a message being communicated within enterprise system 12, extract the data from a read/write operation on enterprise data store 50, request the data from enterprise data store 50, and/or the like. In general, two types of significant events for monitored assets include the creation/addition of a new asset, and subsequent state changes of the asset during its lifecycle. To this extent, event source 14 is shown receiving new asset data 40 and asset state change data 42. As further described herein, event source 14 generates a create message 44 in response to obtaining new asset data 40, and generates an update message 46 in response to obtaining asset state change data 42 for one or more monitored assets.

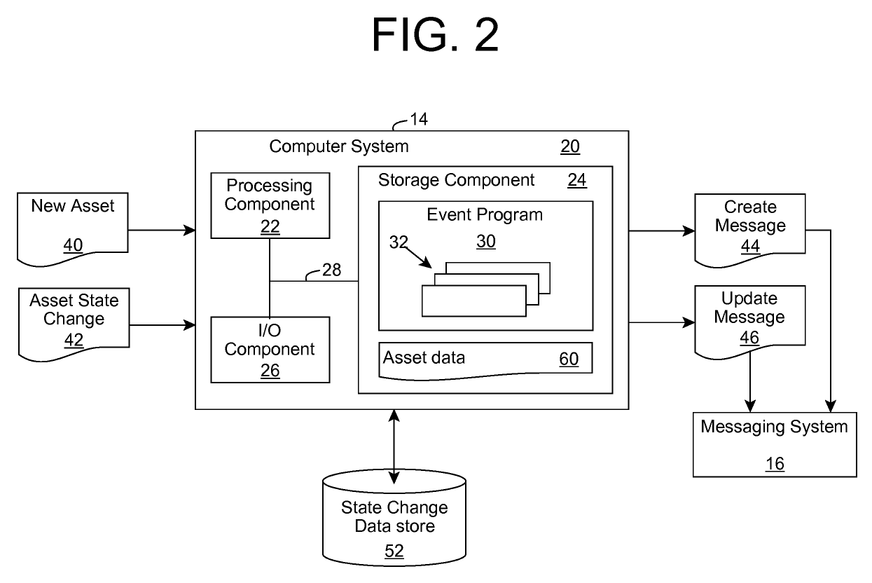

Event source 14 can be implemented in its own computer system (e.g., a computing device), or be implemented as software installed within one or more computing devices of enterprise system 12. In either case, FIG. 2 shows an illustrative implementation of an event source 14 according to an embodiment. In particular, event source 14 is implemented as a computer system 20 including an event program 30, which makes computer system 20 operable to monitor significant events for asset(s) in enterprise system 12 and generate message(s) in response to detecting one or more significant events by performing a process described herein.

Computer system 20 is shown including a processing component 22 (e.g., one or more processors), a storage component 24 (e.g., a storage hierarchy), an input/output (I/O) component 26 (e.g., one or more I/O interfaces and/or devices), and a communications pathway 28. In general, processing component 22 executes program code, such as event program 30, which is at least partially fixed in storage component 24. While executing program code, processing component 22 can process data, which can result in reading and/or writing transformed data from/to storage component 24 and/or I/O component 26 for further processing. Pathway 28 provides a communications link between each of the components in computer system 20. I/O component 26 can comprise one or more human I/O devices, which enable a human user to interact with computer system 20 and/or one or more communications devices to enable a system user (e.g., messaging system 14) to communicate with computer system 20 using any type of communications link. To this extent, event program 30 can manage a set of interfaces (e.g., graphical user interface(s), application program interface, and/or the like) that enable human and/or system users to interact with event program 30. Further, event program 30 can manage (e.g., store, retrieve, create, manipulate, organize, present, etc.) the data, such as entity data 60, using any solution.

In any event, computer system 20 can comprise one or more general purpose computing articles of manufacture (e.g., computing devices) capable of executing program code, such as event program 30, installed thereon. As used herein, it is understood that “program code” means any collection of instructions, in any language, code or notation, that cause a computing device having an information processing capability to perform a particular function either directly or after any combination of the following: (a) conversion to another language, code or notation; (b) reproduction in a different material form; and/or (c) decompression. To this extent, event program 30 can be embodied as any combination of system software and/or application software.

Further, event program 30 can be implemented using a set of modules 32. In this case, a module 32 can enable computer system 20 to perform a set of tasks used by event program 30, and can be separately developed and/or implemented apart from other portions of event program 30. As used herein, the term “component” means any configuration of hardware, with or without software, which implements the functionality described in conjunction therewith using any solution, while the term “module” means program code that enables a computer system 20 to implement the functionality described in conjunction therewith using any solution. When fixed in a storage component 24 of a computer system 20 that includes a processing component 22, a module is a substantial portion of a component that implements the functionality. Regardless, it is understood that two or more components, modules, and/or systems may share some/all of their respective hardware and/or software. Further, it is understood that some of the functionality discussed herein may not be implemented or additional functionality may be included as part of computer system 20. For example, computer system 20 can further include one or more mission-critical applications, which enable enterprise system 12 (FIG. 1) to manage data that is used by the organization to perform day-to-day activities and/or monitor the day-to-day activities and the corresponding assets of the organization. In this case, computer system 20 can comprise a portion of enterprise system 12.

When computer system 20 comprises multiple computing devices, each computing device can have only a portion of event program 30 fixed thereon (e.g., one or more modules 32). However, it is understood that computer system 20 and event program 30 are only representative of various possible equivalent computer systems that may perform a process described herein. To this extent, in other embodiments, the functionality provided by computer system 20 and event program 30 can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 20 includes multiple computing devices, the computing devices can communicate over any type of communications link. Further, while performing a process described herein, computer system 20 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

As discussed herein, when executed by computer system 20, event program 30 makes computer system 20 a special purpose computer system (i.e., an event source 14), which is configured to monitor one or more assets of enterprise system 12 (FIG. 1). To this extent, event source 14 can be configured to monitor one or more assets of enterprise system 12 that comprise, on average, long-lasting assets, and which have a finite and pre-determined number of monitored states during their lifecycles with the organization. For example, a transportation asset (e.g., vehicle, rail car, ship, aircraft, truck, etc.) or an information technology asset (computer hardware or software), can be in one of a pre-determined number of monitored operating states. Similarly, a person, such as an employee, can be in one of a plurality of monitored states (e.g., in office, sick, vacation, meeting, etc.).

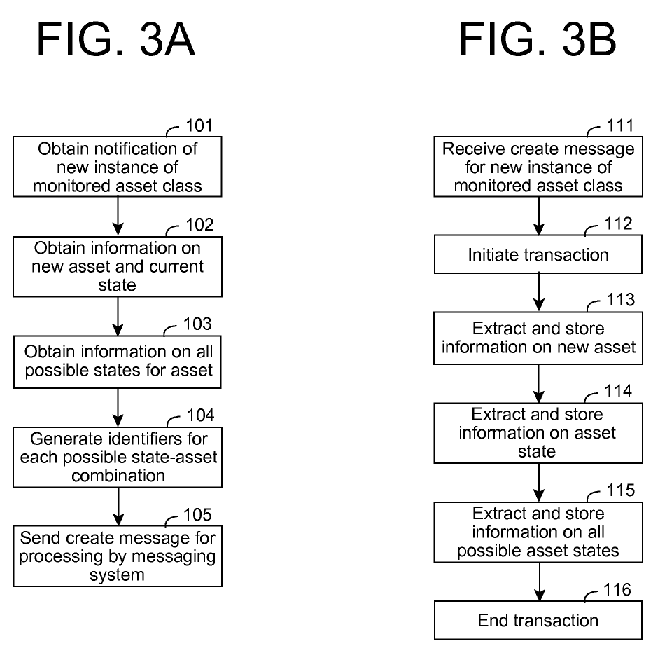

FIGS. 3A-3B show illustrative processes performed in response to a new asset event according to an embodiment. In particular, FIG. 3A shows an illustrative process, which can be implemented by event source 14, of generating and transmitting a create message 44 in response to the new asset event according to an embodiment. Referring to FIGS. 2 and 3A, in process 101, event source 14 obtains a notification of the creation/addition of a new asset of a type of asset being monitored by event source 14. For example, as discussed herein, event source 14 can monitor the operation of component(s) of enterprise system 12 (FIG. 1) and obtain the notification using any solution.

Regardless, in process 102, event source 14 obtains new asset data 40 for the new asset, which can include information on one or more attributes of the new asset, a current state for the new asset, and the like, using any solution. For example, event source 14 can extract some or all of the new asset data 40 from the notification (e.g., a unique identifier for the new asset). Further, event source 14 can request and receive new asset data 40 from enterprise data store 50 (e.g., using a component of enterprise system 12), or the like. In an embodiment, event source 14 only obtains new asset data 40 that is required to enable event source 14, messaging system 16, and monitoring system 18 (FIG. 1) to identify the new asset and process the state changes of the asset. In this case, the new asset data 40 can include information (e.g., a pointer) that enables the retrieval of additional information (e.g., from enterprise data store 50) on the asset should it be required at a later time.

In process 103, event source 14 obtains information on all of the possible states for the new asset. For example, event source 14 can manage asset data 60, which includes data on each of the possible states for a type of asset that event source 14 is monitoring. In an embodiment, event source 14 manages the asset data 60 using any solution, e.g., a database. In this case, event source 14 can obtain the asset data 60 when it is configured to monitor a particular type of asset. Alternatively, event source 14 can obtain the information on all of the possible states from a shared data store, such as enterprise data store 50 (FIG. 1). Regardless, the information for each of the possible states can include information that uniquely identifies the state (e.g., a state identifier) from the other possible states of the asset, as well as information that enables event source 14, messaging system 16, and monitoring system 18 (FIG. 1) to process the corresponding state change for an asset. Additionally, the information can include information (e.g., a pointer) that enables the retrieval of additional information (e.g., from enterprise data store 50) on the state, if required.

In process 104, event source 14 can generate, or otherwise obtain, a unique asset-state identifier for each possible combination of the new asset and a corresponding state of the new asset using any solution (e.g., using a hash or other type of algorithm applied on the identifiers for the state and asset, a creation timestamp for the asset, and/or the like). To this extent, the unique asset-state identifier will uniquely identify the combination of state and asset from all other possible combinations of states and assets being monitored within computing environment 10 (FIG. 1). In this manner, event source 14 can forward only the asset-state identifier that corresponds to a new state for an asset for processing by messaging system 16 in response to a detected state change for the asset. Event source 14 can store the asset-state identifiers and asset and state information in a state change data store 52 using any solution. The stored information can enable event source 14 to later obtain the asset-state identifier that corresponds to an asset state change event. For example, event source 14 can store the asset-state identifier, the asset identifier, and the state identifier in a record along with any additional information that may be required/desired. Subsequently, event source 14 can retrieve the corresponding data from the state change data store 52 for use in processing asset state change data 42.

In process 105, event source 14 can generate a create message 44 based on the new asset data 40 and asset-state identifiers and transmit the create message 44 for processing by messaging system 16. The create message 44 can include an asset record that includes one or more fields comprising data on the new asset (e.g., an asset identifier, an asset location, an asset state, pointer for retrieving additional asset information, and/or the like). Further, the create message 44 can include a plurality of asset-state records, each of which includes one of the plurality of asset-state identifiers and information on the corresponding state of the asset (e.g., state identifier, pointer for retrieving additional state information, and/or the like) that will enable messaging system 16 and/or monitoring system 18 (FIG. 1) to process subsequent state changes for the asset using the asset-state identifier. Event source 14 can use any transmission protocol for packaging the data included in the create message 44 and routing the create message 44 to a corresponding messaging system 16 for further processing. In an embodiment, event source 14 places the create message 44 on a create message queue, which holds incoming create messages 44 for processing by messaging system 16.

FIG. 3B shows an illustrative process, which can be implemented by messaging system 16 and monitoring system 18, for processing the create message 44 according to an embodiment. Referring to FIGS. 1 and 3B, in process 111, messaging system 16 receives the create message 44 for the new asset, which was transmitted by event source 14, using any solution (e.g., by retrieving the create message 44 from a create message queue). In process 112, messaging system 16 initiates a transaction to ensure that the create message 44 is completely processed and that the results of only partial processing of the create message 44 can be rolled back, if necessary.

In process 113, messaging system 16 can extract information on the new asset from the create message 44 and forward the information to monitoring system 18 for storage in monitored asset data store 54. For example, messaging system 16 can extract the asset record and/or information stored therein and provide the information to monitoring system 18. Monitoring system 18 can obtain additional information on the asset from, for example, enterprise data store 50. Regardless, monitoring system 18 can persist the information in monitored asset data store 54 using any solution (e.g., by adding a stored asset record that includes the information to, for example, a database table).

In process 114, messaging system 16 can extract information on the current state of the new asset from the asset record in the create message 44. The current state can comprise a unique identifier for the state or the like, which messaging system 16 can provide to monitoring system 18. Monitoring system 18 can persist the current state, and any additional information, in monitored asset data store 54 using any solution (e.g., by updating the stored asset record for the asset with information on the current state).

In process 115, messaging system 16 can extract information on all of the possible states for the asset from each of the plurality of asset-state records in the create message 44. The information for each possible state for the asset will include a unique asset-state identifier and information on the corresponding state of the asset (e.g., state identifier, pointer for retrieving additional state information, and/or the like). Further, messaging system 16 can include an asset identifier for the corresponding asset with the information. Messaging system 16 can provide the information on each possible state for the asset to monitoring system 18. Monitoring system 18 can persist the information on each possible state for the asset in monitored asset data store 54 using any solution (e.g., by adding a stored asset-state record for each possible state for the asset to, for example, a database table). In process 116, once all the information has been successfully persisted in monitored asset data store 54, messaging system 16 can end the transaction.

Once information on a new asset is persisted in monitored asset data store 54, monitoring system 18 can include information on the asset and/or update information on a group of assets in a set of user interfaces generated and updated by monitoring system 18 for presentation to one or more users (e.g., a set of business activity monitoring (BAM) user interfaces for presentation to high-level managers). Additionally, monitoring system 18 can obtain additional information on the asset from enterprise data store 50, which monitoring system 18 can include in one or more of the user interfaces. The set of user interfaces enable the user(s) to view the current status of a business in real time. To this extent, when the state of a monitored asset changes, it is desirable that the state change be reflected in the set of user interfaces generated and managed by monitoring system 18 as quickly as possible.

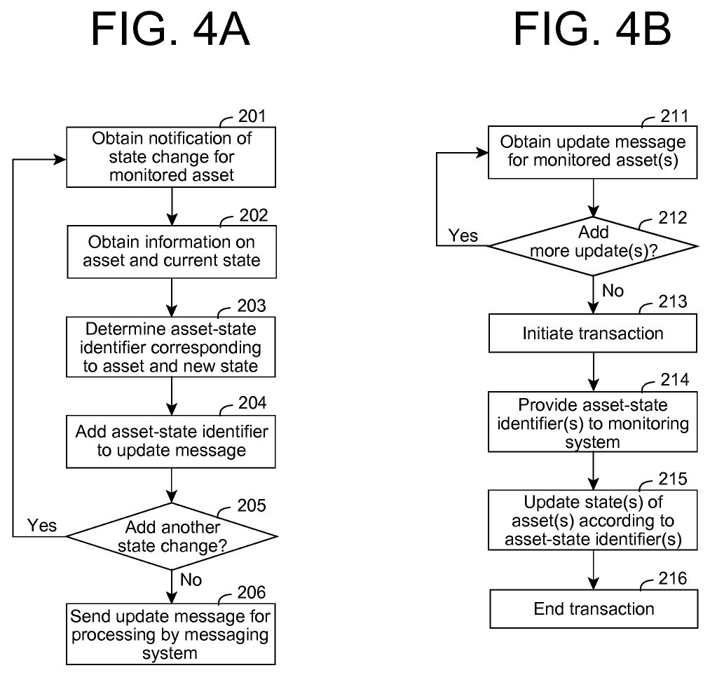

FIGS. 4A-4B show illustrative processes performed in response to a set of asset state change events according to an embodiment. In particular, FIG. 4A shows an illustrative process, which can be implemented by event source 14, of generating and transmitting an update message 46 in response to one or more asset state change events according to an embodiment. Referring to FIGS. 2 and 4A, in process 201, event source 14 obtains a notification of the state change for a monitored asset. For example, as discussed herein, event source 14 can monitor the operation of component(s) of enterprise system 12 (FIG. 1) and obtain the notification using any solution.

In process 202, event source 14 obtains asset state change data 42 for the state change, which can include a unique identifier for the asset for which the state changed and a unique identifier for the new state of the asset, using any solution. For example, event source 14 can extract some or all of the asset state change data 42 from the notification, obtain some or all of the asset state change data 42 from enterprise data store 50, and/or the like. In process 203, event source 14 determines the asset-state identifier that corresponds to the monitored asset and its new state using any solution. For example, event source 14 can retrieve the asset-state identifier from state change data store 52 using the unique identifiers for the asset and the new state.

In process 204, event source 14 adds the asset-state identifier to an update message 46, which will be provided to messaging system 16 for processing. In process 205, event source 14 determines whether to add another asset-state identifier corresponding to another asset state change event to the update message 46 using any solution. For example, when event source 14 obtains notifications of numerous state change events within a short period of time, event source 14 can combine multiple asset-state identifiers into a single update message 46. In this manner, the amount of update messages 46 transmitted for processing by messaging system 16 can be reduced without having a substantial impact on the currency of the status information within monitored asset data store 54. Alternatively, event source 14 can only include one asset-state identifier per update message 46 when messaging system 16 can timely process the update messages 46.

Additionally, event source 14 can determine whether messaging system 16 is currently unavailable for processing update messages 46 using any solution. For example, messaging system 16 can periodically send a message (e.g., a heartbeat) to event source 14 indicating that it is available to process messages, send an acknowledgement message in response to receiving a create message 44 or an update message 46, and/or the like. When event source 14 has not received a message from messaging system 16 for a predetermined amount of time and/or amount of messages, event source 14 can assume that messaging system 16 is not available for processing messages. In this case, event source 14 can continue to process asset state change events and add the corresponding asset-state identifiers to an update message 46. Further, when multiple asset status change events for the same asset are processed by event source 14 prior to sending an update message 46, event source 14 can remove the older asset status change event from the update message 46. Regardless, event source 14 can limit a number of asset-state identifiers included in a single update message 46 based on, for example, a pre-determined size limitation for the update message 46 set by the transmission protocol.

Once event source 14 determines that no more asset state change events are to be added to the update message 46, event source 14 can send the update message 46 for processing by messaging system 16 in process 206. In an embodiment, event source 14 can place the update message 46 on an update message queue, which holds incoming update messages 46 for processing by messaging system 16. As discussed herein, it is understood that event source 14 may not immediately send an update message 46 to messaging system 16, but rather may wait to send the update message 46 until event source 14 identifies that messaging system 16 is ready to process the update message 46.

FIG. 4B, shows an illustrative process, which can be implemented by messaging system 16 and monitoring system 18, for processing the update message 46 according to an embodiment. Referring to FIGS. 1 and 4B, in process 211, messaging system 16 obtains the update message 46, which was transmitted by event source 14, using any solution (e.g., by retrieving the update message 46 from an update message queue). In process 212, messaging system 16 can determine whether to process the data from one or more additional update messages 46 at the same time as the update message 46. For example, messaging system 16 can retrieve each update message 46 in the update message queue (e.g., up to a maximum number of update messages 46) and process all of the retrieved update messages 46 in a single transaction. Additionally, similar to event source 14, messaging system 16 can determine that monitoring system 18 is currently unavailable to process update messages 46. In this case, messaging system 16 can wait until it determines that monitoring system 18 is available before starting the transaction and processing some or all of the update messages 46 that have been received in a single transaction.

In process 213, messaging system 16 initiates a transaction for processing the data in the update message(s) 46 to ensure that the update message(s) 46 is/are completely processed and that the results of only partial processing of the update message(s) 46 can be rolled back, if necessary. In process 214, messaging system 16 can extract and provide the asset-state identifier(s) from each of the update message(s) 46 to monitoring system 18 for updating monitored asset data store 54. In process 215, monitoring system 18 updates the data in monitored asset data store 54 to reflect the current state of each asset according to the corresponding asset-state identifier. For example, monitoring system 18 can use the asset-state identifier to obtain the asset identifier and the state identifier that correspond to the asset-state identifier. Monitoring system 18 can use the asset identifier to update the stored asset state with the state identifier (or some other representation of the current state) using any solution. In an embodiment, monitoring system 18 can use the asset-state identifier to retrieve a stored asset-state record that includes the asset identifier and the state identifier, and subsequently use the retrieved asset identifier to update a current state field in a stored asset record with the state identifier. Regardless, once all asset-state identifiers have been processed by monitoring system 18, messaging system 16 can end the transaction in process 216.

Once the update information has been processed to update monitored asset data store 54, monitoring system 18 can update asset information, such as information on the asset(s) and/or update information on a group of related assets, included in the set of user interfaces managed by monitoring system 18 for presentation to one or more users as discussed herein.

Returning to FIG. 1, when the processing of a create message 44 or an update message 46 fails, messaging system 16 can generate and transmit a fail message 48 for processing by event source 14. To this extent, event source 14 can include exception handling, which can prevent further failures in the processing. For example, the processing of one or more asset-state identifiers in an update message 46 may fail due to a lost create message 44. In this case, event source 14 can generate and transmit another create message 44 for the asset as described herein, which includes information on the current state of the asset. When multiple asset-state identifiers are being processed in a single transaction, messaging system 16 can identify the asset-state identifier(s) that is/are causing the failure (e.g., based on error data obtained from monitoring system 18), e.g., by removing an asset-state identifier that caused the failure, and resubmitting the remainder in a new transaction. Subsequently, messaging system 16 can generate and transmit a fail message 48 that includes each asset-state identifier that failed for processing by event source 14.

While computing environment 10 is shown only including a single event source 14, it is understood that computing environment 10 can include any number of event sources 14. Similarly, computing environment 10 could include multiple messaging systems 16 and/or multiple monitoring systems 18, each of which processes create messages 44 and update messages 46 from a unique set of event sources 14. Further, while computing environment and the illustrative processes described herein have been shown and described in conjunction with distinct systems 12, 14, 16, 18, and distinct data stores, 50, 52, 54, it is understood that this is only illustrative and numerous alternative implementations are possible. For example, messaging system 16 and monitoring system 18 could be implemented as a single system. Further, monitored asset data store 54 and state change data store 52 could comprise a single data store that is shared by the systems. Still further, it is understood that enterprise system 12, messaging system 16, and monitoring system 18 can include similar components as shown and described in FIG. 2 with respect to event source 14.

While shown and described herein as a method and system for processing asset-related events, it is understood that aspects of the invention further provide various alternative embodiments. For example, in one embodiment, the invention provides a computer program fixed in at least one computer-readable medium, which when executed, enables a computer system to process asset-related events. To this extent, the computer-readable medium includes program code, such as event program 30 (FIG. 1), which implements some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; and/or the like.

In another embodiment, the invention provides a method of providing a copy of program code, such as event program 30 (FIG. 1), which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for processing asset-related events. In this case, a computer system, such as computer system 20 (FIG. 1), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; and/or the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A computer-implemented method of monitoring assets, the method comprising:
receiving asset state change data for an asset at a first computer system, wherein the asset is a physical object utilized by an enterprise and wherein the asset change data includes a current state of the asset;
generating an update message based on the asset state change data with the first computer system, wherein the generating includes:
obtaining an asset-state identifier corresponding to a combination of the current state for the asset and the asset, wherein the asset-state identifier uniquely identifies the combination from all other possible combinations of assets and states being monitored; and
adding the unique identifier to the update message; and
transmitting the update message for processing by a second computer system.

2. The method of claim 1, wherein the generating further includes obtaining and adding a second asset-state identifier corresponding to a second combination of a current state for a second asset and the second asset, wherein the second asset is a different physical object utilized by the enterprise.

3. The method of claim 1, further comprising:
initiating a transaction at the second computer system in response to receiving the update message; and
updating a record for the asset stored in a monitored asset data store within the transaction using the asset-state identifier, wherein the record indicates the current state of the asset.

4. The method of claim 3, further comprising updating asset information included in a user interface in response to the updating.

5. The method of claim 1, further comprising:
receiving new asset data at the first computer system for the asset; and
generating a plurality of asset-state identifiers based on the new asset data with the first computer system, wherein each asset-state identifier in the plurality of asset-state identifiers corresponds to a unique combination of a unique state in a plurality of possible states for the asset and the asset.

6. The method of claim 5, further comprising:
generating a create message, wherein the create message includes an asset record including a set of asset fields comprising at least a portion of the new asset data and a plurality of asset-state records, each asset-state record including one of the plurality of asset-state identifiers and the unique state corresponding to the one of the plurality of asset-state identifiers; and
transmitting the create message for processing by the second computer system.

7. The method of claim 6, further comprising:
initiating a transaction at the second computer system in response to receiving the create message; and
storing a plurality of records in a monitored asset data store for the new asset within the transaction, wherein the plurality of records includes a stored asset record including the set of asset fields and a plurality of stored asset-state records, each stored asset-state record including data for one of the plurality of asset-state records in the create message and a unique identifier for the asset.

8. A computer system for monitoring assets, the computer system comprising:
an event source including:
a component configured to receive asset state change data for an asset, wherein the asset change data includes a current state of the asset;
a component configured to generate an update message based on the asset state change data by obtaining an asset-state identifier corresponding to a combination of the current state for the asset and the asset, wherein the asset-state identifier uniquely identifies the combination from all other possible combinations of assets and states being monitored, and adding the unique identifier to the update message; and
a component configured to transmit the update message for processing by a messaging system.

9. The system of claim 8, wherein the component configured to generate generates the update message by further obtaining and adding a second asset-state identifier corresponding to a second combination of a current state for a second asset and the second asset, wherein the second asset is a different physical object utilized by the enterprise.

10. The system of claim 8, further comprising:
the messaging system, wherein the messaging system includes a component configured to initiate a transaction in response to receiving the update message; and
a monitoring system configured to update a record for the asset stored in a monitored asset data store within the transaction using the asset-state identifier, wherein the record indicates the current state of the asset.

11. The system of claim 10, wherein the monitoring system is further configured to update asset information included in a user interface in response to the updating.

12. The system of claim 8, the event source further including:
a component configured to generate a plurality of asset-state identifiers in response to receiving new asset data for the asset, wherein each asset-state identifier in the plurality of asset-state identifiers corresponds to a unique combination of a unique state in a plurality of possible states for the asset and the asset;
a component configured to generate a create message, wherein the create message includes an asset record including a set of asset fields comprising at least a portion of the new asset data and a plurality of asset-state records, each asset-state record including one of the plurality of asset-state identifiers and the unique state corresponding to the one of the plurality of asset-state identifiers; and
a component configured to transmit the create message for processing by the messaging system.

13. The system of claim 12, wherein the messaging system further includes a component configured to initiate a transaction in response to receiving the create message, and wherein the monitoring system further includes a component configured to store a plurality of records in a monitored asset data store for the new asset within the transaction, wherein the plurality of records includes a stored asset record including the set of asset fields and a plurality of stored asset-state records, each stored asset-state record including data for one of the plurality of asset-state records in the create message and a unique identifier for the asset.

14. A computer program comprising program code embodied in at least one computer-readable medium, which when executed, enables a computer system to implement a method of monitoring assets, the method comprising:
receiving asset state change data for an asset, wherein the asset is a physical object utilized by an enterprise and wherein the asset change data includes a current state of the asset;
generating an update message based on the asset state change data, wherein the generating includes:
obtaining an asset-state identifier corresponding to a combination of the current state for the asset and the asset, wherein the asset-state identifier uniquely identifies the combination from all other possible combinations of assets and states being monitored; and
adding the unique identifier to the update message; and
transmitting the update message for processing by a second computer system.

15. The computer program of claim 14, wherein the generating further includes obtaining and adding a second asset-state identifier corresponding to a second combination of a current state for a second asset and the second asset, wherein the second asset is a different physical object utilized by the enterprise.

16. The computer program of claim 14, the method further comprising:
receiving new asset data for the asset; and
generating a plurality of asset-state identifiers based on the new asset data, wherein each asset-state identifier in the plurality of asset-state identifiers corresponds to a unique combination of a unique state in a plurality of possible states for the asset and the asset.

17. The computer program of claim 16, the method further comprising:
generating a create message, wherein the create message includes an asset record including a set of asset fields comprising at least a portion of the new asset data and a plurality of asset-state records, each asset-state record including one of the plurality of asset-state identifiers and the unique state corresponding to the one of the plurality of asset-state identifiers; and
transmitting the create message for processing by the second computer system.

18. A method of generating a computer system for monitoring assets, the method comprising:
providing a computer system operable to:
receive asset state change data for an asset at a first computing device, wherein the asset is a physical object utilized by an enterprise and wherein the asset change data includes a current state of the asset;
generate an update message based on the asset state change data with the first computing device, wherein the generating includes:
obtaining an asset-state identifier corresponding to a combination of the current state for the asset and the asset, wherein the asset-state identifier uniquely identifies the combination from all other possible combinations of assets and states being monitored; and
adding the unique identifier to the update message; and
transmit the update message for processing by a second computing device.

19. The method of claim 18, wherein the computer system is further operable to:
initiate a transaction at the second computing device in response to receiving the update message; and
update a record for the asset stored in a monitored asset data store within the transaction using the asset-state identifier, wherein the record indicates the current state of the asset.

20. The method of claim 19, wherein the computer system is further operable to update asset information included in a user interface in response to the record update.
